(19) United States
(12) Patent Application Publication
(10) Pub. No.: US 2007/0020431 A1
(43) Pub. Date: Jan. 25, 2007

(54) Method for the production of a fibre composite material component and intermediate product for such a method

(75) Inventors: Jan Nowacki, Donauwoerth (DE); Christian Weimer, Geiselburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Eurocopter Deutschland GmbH, Donauwoerth (DE)

(21) Appl. No.: 10/558,457

(22) PCT Filed: May 26, 2004
(86) PCT No.: PCT/EP04/05649

§ 371 Date: Nov. 28, 2005

(30) Foreign Application Priority Data
May 26, 2003 (DE) 103 24 141.8

(51) Int. Cl. B29C 70/44; B32B 3/06

(52) U.S. Cl. 428/102; 264/258; 264/271.1; 264/324; 264/328.1; 428/542.8

(57) ABSTRACT

A method for producing a component made of fiber composite material includes sewing a plurality of reinforcing-fiber layers together using a thread to create a seam and to form at least one reinforcing-fiber preform, wherein the seam has a predetermined thread tension and the sewing pre-compacts the reinforcing-fiber preform to a pre-compacting size. The at least one reinforcing-fiber preform is placed into an injection mold. A final compacting of the reinforcing-fiber preform to a final compacting size is performed by closing the injection mold, wherein the final compacting includes relaxing the thread tension of the seam. A resin is injected into the injection mold and the resin is cured. In addition, an intermediate product includes at least one reinforcing-fiber perform.

### FIELD OF THE INVENTION

The present invention relates to a method for the production of a component made of fiber composite material according to the generic part of claim 1 as well as to an intermediate product for such a method.

### DESCRIPTION OF RELATED ART

A method for the production of a component made of fiber composite material is known in which several reinforcing-fiber layers are sewed and joined together using a thread to form reinforcing-fiber preforms, whereby the seam has a prescribed thread tension, and the reinforcing-fiber preforms are compacted by means of the sewing and a large number of reinforcing-fiber preforms is placed into an injection mold, the injection mold is closed and a resin is injected into the injection mold, after which the resin is cured. In this prior-art method, the reinforcing-fiber preforms are compacted by means of the sewing to, or essentially to, a final compacting size or to a desired thickness.

The above-described method according to the state of the art, however, has several drawbacks. For instance, it has been found that, during the sewing and compacting, the reinforcing fibers are markedly re-orientated, or even destroyed, which at times drastically reduces the strength of the component made of fiber composite material. This is considered to be a detrimental aspect, particularly for components made of fiber composite material that are used in the aerospace industry since these have to be designed so as to be not only light in weight but also high in strength. Moreover, the placement of the numerous reinforcing-fiber preforms into the injection mold—which has to be done in the correct sequence—as well as their alignment are quite complex, tedious and time-consuming. Moreover, it has been found that problems are often encountered with the closing of the injection mold. However, if the injection mold is not closed, the risk exists that resin might leak out and that the reinforcing material is not completely impregnated.

Likewise known are methods that function according to the principle of resin transfer molding (RTM) for the production of a component made of fiber composite material in which method reinforcing-fiber preforms are made in a separate compacting process. Such a method is schematically depicted in FIG. 4. In order to produce the preforms 12, one or more reinforcing-fiber layers slightly impregnated with resin are draped over a shape-imparting production means that is adapted to the component to be manufactured and then cured, resulting in a preform 12 that is relatively stable on its own (S1). In this manner, a relatively large number of preforms 12 is made. These preforms 12 are then placed one after the other in the correct sequence into an injection mold 14 (S2), the injection mold 14 is closed (S3), a vacuum or low pressure is established in the injection mold 14 (S4), a resin 16 is injected into the injection mold (S5) and the injected resin 16 is cured (S6). Subsequently, the fiber composite material component 18 thus produced is removed from the mold 14 (S7).

In the case of this prior-art method as well, the placement of the numerous reinforcing-fiber preforms into the injection mold in a precisely prescribed sequence is relatively complex, tedious and time-consuming, in addition to which problems are likewise encountered with the closing of the injection mold, thus leading to the above-mentioned disadvantageous consequences.

German patent application DE 196 08 127 A1 discloses a method for the production of a component made of fiber composite material in which several reinforcing-fiber layers as well as local reinforcing parts are sewed and joined together using a thread to form a single reinforcing-fiber preform that can be handled as a whole. The reinforcing parts are only sewed in their edge area. The sewing serves to affix the reinforcing-fiber layers and the reinforcing parts to each other and also to prevent a shifting of the reinforcing-fiber layers or a disorientation of the fiber layer structure during transportation, storage or a subsequent spatial or three-dimensional forming in a compression molding tool. The three-dimensional forming as well as the consolidation in the compression molding tool are carried out under the effect of pressure and heat.

### SUMMARY OF THE INVENTION

The invention is based on the objective or technical problem of creating a method of this generic type for the production of a component made of fiber composite material that largely avoids the disadvantages associated with the state of the art and that allows the manufacture of a high-quality component made of fiber composite material having improved mechanical properties. Moreover, a suitable intermediate product for use in such a method is to be put forward.

This objective is achieved according to a first aspect by means of the method according to the invention having the features of claim 1.

This method for the production of a component made of fiber composite material, in which
several (that is to say, two or more) reinforcing-fiber layers are sewed and joined together using a thread to form reinforcing-fiber preforms, whereby the seam has a prescribed thread tension, and the reinforcing-fiber preforms are compacted by means of the sewing, and the reinforcing-fiber preforms are placed into an injection mold, the injection mold is closed and a resin is injected into the injection mold, after which the resin is cured,
is characterized in that,
when the reinforcing-fiber layers are sewed, the reinforcing-fiber preforms are first pre-compacted to a pre-compacting size,
the reinforcing-fiber preforms placed into the injection mold then undergo final compacting to a final compacting size by means of the closing of the injection mold, and this final compacting relaxes the seam that is under a prescribed thread tension (that is to say, the seam between the two or more reinforcing-fiber layers that are adjacent to each other or that lie on top of one another, or optionally the reinforcing-fiber preforms that are joined to each other). The final compacting can be done in one or more directions as a function of the fiber arrangement of the appertaining reinforcing-fiber preforms in the component to be manufactured, or else for each reinforcing-fiber preform individually or for a preform subunit made up of several reinforcing-fiber preforms, but in a uniform direction.

The reinforcing-fiber layers, which can be the same or different fiber fabric or fiber structures (for example, fiberglass fabrics, carbon-fiber fabric, or also unidirectional fiber arrangements, etc.) are preferably sewed while in a dry state. In other words, the reinforcing-fiber layers have not yet been provided with a resin that constitutes a local adhesive or else later a matrix. Even though it is fundamentally possible within the scope of the method according to the invention for the component made of fiber composite material to be manufactured on the basis of a single sewed reinforcing-fiber preform or of a single preform subunit consisting of several reinforcing-fiber preforms that is/are placed into the injection mold, it is, however, preferable to use a certain number of several reinforcing-fiber preforms or preform subunits and to place them into the injection mold, as will still be explained in greater detail below.

The reinforcing-fiber preforms employed to produce the component made of fiber composite material are appropriately adapted to the shape of the component to be manufactured or to certain areas of the component and to the injection mold. The individual reinforcing-fiber preforms, however, do not necessarily have to have an identical or similar shape. Rather, depending on the desired shape of the component made of fiber composite material, different reinforcing-fiber preforms or groups and subunits of such reinforcing-fiber preforms can be used inside this component. The reinforcing-fiber preforms are each advantageously placed into the injection mold in a suitable sequence or according to a prescribed arrangement or placement pattern. The placed reinforcing-fiber preforms or preform groups can overlap completely or else only partially inside the injection mold.

The method according to the invention makes it possible to largely avoid the drawbacks associated with the state of the art in a simple, effective and advantageous manner as well as to achieve a high-quality component made of fiber composite material having improved mechanical properties.

The inventors of the present novel method have recognized that, with the methods according to the state of the art—in which the reinforcing-fiber layers already undergo final compacting to a final size or a final-compacting size by means of the sewing—marked re-orientations or even destruction of the reinforcing fibers occur, especially in the area of the seam and of the sewing needle holes that are inevitably created during the sewing, and these effects are no longer reversible owing to the given process steps and procedures. In addition to the disadvantages stemming from the re-orientations of the reinforcing fibers, the sewing thread holes also give rise to relatively large, funnel-like indentations in the contour of the reinforcing-fiber preforms. When the resin is subsequently injected, non-reinforced and thus very brittle or breakable resin accumulations can be formed in these indentations, which is likewise detrimental to the strength of the component.

With the solution according to the invention, in contrast, the pre-compacting brought about by the sewing firstly ensures that the individual reinforcing-fiber layers are sufficiently strong and are joined to each other so that they cannot shift and so that they can be easily placed into the injection mold in the form of at least one reinforcing-fiber preform. Since the reinforcing-fiber preform (or the preform subunit) does not yet have its final thickness or material thickness size, it is compressed even further when the mold is closed, and only in this process does it undergo final compacting to its final compacting size. As a result, the final thickness of the reinforcing material is established.

It is quite evident that here, the seam that is under a prescribed thread tension as a result of the preceding sewing procedure can relax since the original thickness of the reinforcing-fiber preform (or of the preform subunit) diminishes due to the final compacting, even though the length of the sewed thread remains the same. The relaxation effect is naturally further enhanced when a thread having a high relaxation capacity is employed. The result of this relaxation of the seam is that the seam thread in the area of a needle insertion point or of the sewing thread holes created there does not pull together or re-orient itself at all any more, or at least not so markedly. Therefore, unfavorable fiber patterns or even a destruction of the fibers can be effectively prevented.

Therefore, when one looks at the cross section of the sewed reinforcing-fiber preform, the relaxed seam (which in modern sewing techniques normally consists of a top thread and a bottom thread) acquires a virtually rectangular seam or thread pattern. As a result, in turn, the relatively large funnel-like indentations in the contour of the reinforcing-fiber preform (or in the contour and structure of the preform subunit) that occur in the state of the art can no longer form. Consequently, large, non-reinforced resin accumulations can no longer form during the subsequent injection of the resin. As a result, the strength of the component made of fiber composite material manufactured with the method according to the invention can be considerably increased.

It should be pointed out that the above-mentioned advantages can also be achieved when a relatively large number of reinforcing-fiber layers is sewed together to form a reinforcing-fiber preform.

Consequently, the production of a component made of fiber composite material only calls for a relatively small number of reinforcing-fiber preforms (or preform subunits) that can be easily, quickly and efficiently placed into the injection mold one after the other and aligned there. The small number of necessary reinforcing-fiber preforms (or preform subunits) concurrently prevents excessive slipping or shifting of the reinforcing-fiber preforms in the injection mold, which reduces jamming of the preforms due to protruding fiber or preform areas when the injection mold is closed, thus eliminating the need for any reworking of the reinforcing-fiber preforms (or preform subunits). Closing the mold is also facilitated by the compressibility of the reinforcing-fiber preforms (or preform subunits) resulting from the pre-compacting to a pre-compacting size that does not yet constitute the final thickness of the reinforcing material.

Whereas sewed reinforcing-fiber preforms already compacted to a final size or preforms compacted in a separate process and made of reinforcing-fiber layers impregnated with resin can block the closing of the injection mold since the already final thickness of these elements does not match the closing size of the injection mold due to the manufacturing tolerances that are inevitably present, in the case of the method according to the invention, the placed reinforcing-fiber preforms can still be easily compressed together when the injection mold is closed. This not only allows the injection mold to be closed without any problems and reduces the risk of resin leaking out of the injection mold and of insufficient impregnation of the reinforcing material, but in an advantageous manner, also translates into a dimension-tolerant manufacturing technique without impairing the strength of the component to be made of the fiber composite material.

Additional preferred and advantageous embodiment features of the method according to the invention are the subject matter of the subordinate claims 2 to 8.

The objective upon which the invention is based is solved according to a second aspect by means of an intermediate product according to the invention having the features of claim 9.

This intermediate product, especially for use in a method according to one or more of claims 1 to 8, comprises at least one reinforcing-fiber preform which has several reinforcing-fiber layers sewed together with a seam and which, due to the sewing, is pre-compacted to a pre-compacting size at which the seam is under a prescribed thread tension and which can undergo final compacting to a final-compacting size at which the seam is relaxed, due to the prescribed thread tension. It should be noted that the term “a” seam as employed in the invention naturally does not refer to only one single seam, but rather, to one or more seams, depending on the embodiment.

With the intermediate product according to the invention, essentially the same advantages can be achieved as already elaborated upon above in conjunction with the method according to the invention.

A preferred embodiment feature of the intermediate product according to the invention is the subject matter of subordinate claim 10.

Preferred embodiments of the invention with additional embodiment details and other advantages will be described and explained in greater detail below with reference to the accompanying drawings.

### BRIEF DESCRIPTION OF THE DRAWINGS

The following is shown:

FIG. 1—a schematic, greatly simplified cross section through an intermediate product according to the invention in a first stage of the method according to the invention; and

FIG. 2—a schematic, greatly simplified cross section through the intermediate product according to the invention of FIG. 1 in a second stage of the method according to the invention;

FIG. 3—a schematic, greatly simplified cross section through a partial area of a component made of fiber composite material manufactured by means of a first method according to the state of the art;

FIG. 4—a schematic depiction of a second prior-art method for the production of a component made of fiber composite material according to the state of the art.

### PRESENTATION OF PREFERRED EMBODIMENTS

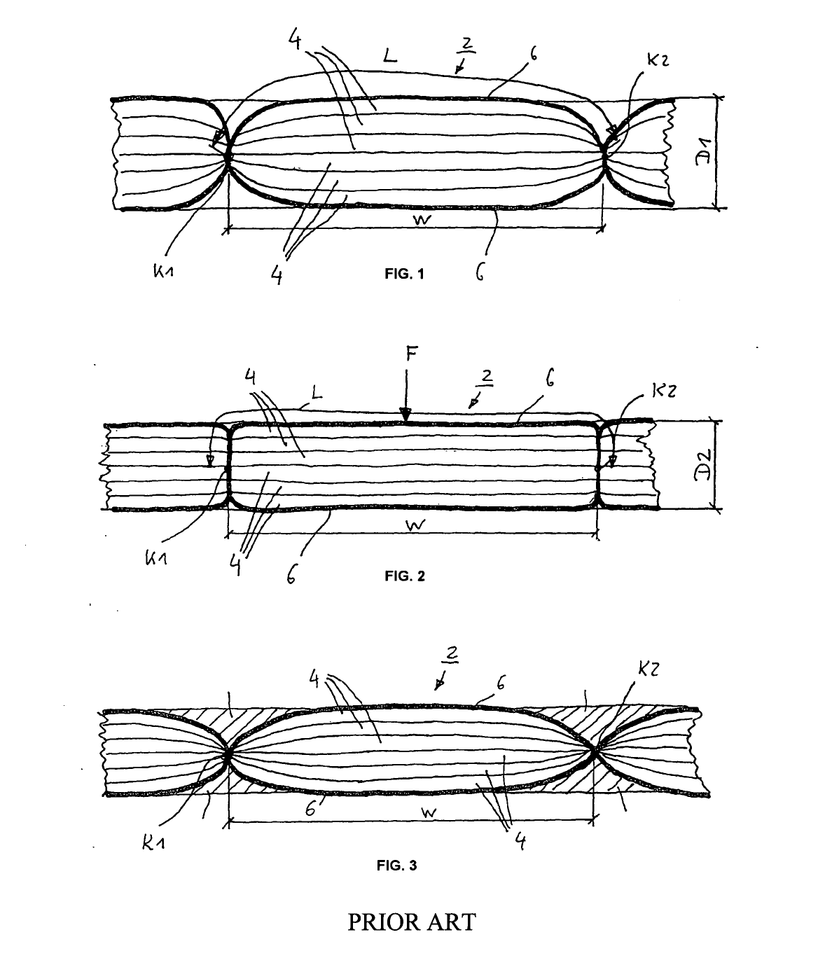

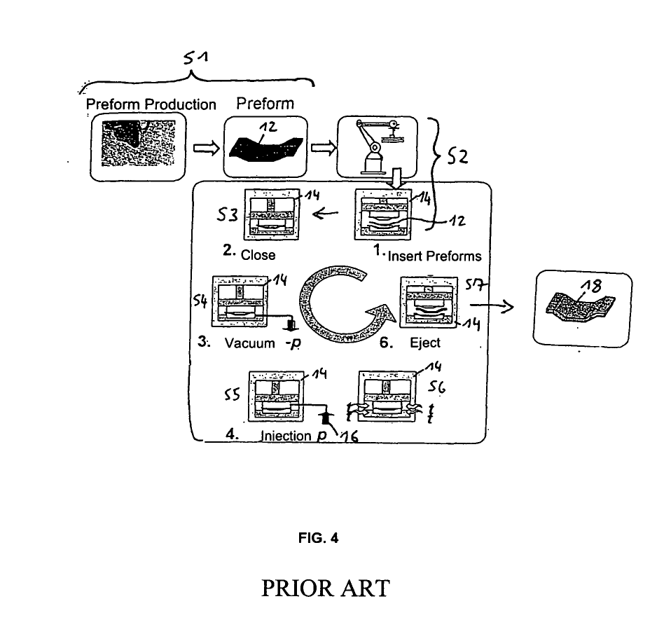

FIG. 1 shows a schematic cross section of an intermediate product according to the invention in a first stage of the method according to the invention. FIG. 2 shows a schematic cross section through the intermediate product according to the invention as shown in FIG. 1 in a second stage of the method according to the invention. As can be seen in these drawings, the intermediate product according to the invention comprises at least one reinforcing-fiber preform 2 that has several reinforcing-fiber layers 4 that lie on top of one another and that are sewed or joined together by means of a seam 6, in other words, by a sewed thread (here: top and bottom threads). As a result of the sewing, the reinforcing-fiber preform 2 is pre-compacted to a reinforcing-material thickness or to a pre-compacting size D1 at which the seam 6 is under a prescribed thread tension (see FIG. 1). Starting with this pre-compacting size D1 and with the prescribed thread tension, the reinforcing-fiber preform 2 undergoes final compacting to a final thickness or a final-compacting size D2 at which the seam is relaxed in comparison to the state shown in FIG. 1 (see FIG. 2). In the case of the intermediate product according to the invention, two or more pre-compacted reinforcing-fiber preforms 2 can be sewed together to form a pre-compacted preform subunit.

The intermediate product according to the invention can be used within the scope of the method according to the invention for the production of a component made of fiber composite material.

With the method according to the invention, first of all several reinforcing-fiber layers 4 are prepared which have been matched to the shape of the component to be made of reinforcing-fiber material as well as to the injection mold employed within the scope of the method according to the invention. These reinforcing-fiber layers 4 are sewed and thus joined together by means of a thread or a seam 6 to form reinforcing-fiber preforms. As a result of the sewing of the reinforcing-fiber layers 4, which is done, for instance, by applying suitable pressure onto the reinforcing-fiber layers 4 and with a sewing thread tension that can be adjusted on a suitable sewing machine, the appertaining reinforcing-fiber preform 2 is first pre-compacted to a pre-compacting size D1. This size D1 does not yet correspond to the final reinforcing material thickness. In other words, the reinforcing-fiber preform 2 can still be further compressed without a need to apply much force. In this state, which is depicted in FIG. 1, the finished seam 6 has a prescribed thread tension which is determined especially by technical sewing parameters and by the tendency of the sewed reinforcing-fiber layers 4 to strive apart from each other.

Even though it is not absolutely necessary, the sewing of the reinforcing-fiber layers 4 in this embodiment and the pre-compacting of each of the reinforcing-fiber preforms 2 are done with a thread that has a high relaxation capacity. This improves the subsequent relaxation of the seam 6.

Fundamentally, the multiple reinforcing-fiber layers 4 can also be temporarily joined together or affixed to each other before, during or after the pre-compacting procedure at one or more places, for example, in a punctiform manner, by means of an adhesive such as, for instance, a thermoplastic resin or the like. As a rule, however, this is not necessary.

The individual reinforcing-fiber preforms 2 now have essentially the state shown in FIG. 2. The produced reinforcing-fiber preforms 2 can either be individually conveyed to additional process steps right away or else they can be sewed to form pre-compacted preform subunits still before being placed into the injection mold.

On the basis of the configuration shown in FIG. 1, the reinforcing-fiber preforms 2 (or the preform subunits) are placed loosely one after the other into a closeable injection mold that can have, for example, a bottom part and a top part that can be affixed thereupon. The injection mold is then closed. In this process, the upper part presses down on the placed reinforcing-fiber preforms 2 (or preform subunits) and compacts them further in a direction running essentially perpendicular to the main fiber direction, as indicated in FIG. 2 by an individual force vector F. Thus, when the injection mold is closed, the reinforcing-fiber preforms 2 (or the preform subunits) undergo final compacting to reach the final-compacting size D2 (wherein D2<D1). Preferably, the final-compacting size D2 amounts to approximately 70% to 90% , especially 75% to 80% , of the pre-compacting size D1. However, depending on the application case, it is possible to diverge from these values by several percent. As a result of this final compacting, the seam 6—which is under a prescribed thread tension—of a given reinforcing-fiber preform 2 relaxes. This state is indicated in FIG. 2 for an individual reinforcing-fiber preform 2.

A comparison between FIGS. 1 and 2 makes it even easier to understand the relaxation principle upon which the invention is based. In the pre-compacted state (FIG. 1), the reinforcing fibers of the sewed reinforcing-fiber layers 4 are still pulled together relatively tightly and re-oriented by the seams 6, which are under a relatively high thread tension. Between two adjacent seam knots K1, K2, the seams 6 display a curved pattern. The partial length L of the thread between two adjacent seam knots K1, K2 (which is determined by the stitch width W during sewing) is essentially constant. During the final compacting procedure, the thickness of a given reinforcing-fiber preform 2 (or of a given preform subunit) decreases from the pre-compacting size D1 to the final compacting size D2.

The distance between the two adjacent seam knots K1, K2 as well as the partial length L of the thread between the seam knots K1, K2, however, remains essentially the same. Now, in a manner of speaking, the partial length L of the thread is too long with respect to the final compacting size M2. As a result, the seam 6, which before was under a relatively high thread tension, becomes somewhat loose and thus considerably relaxed. The reinforcing fibers, which were originally strongly compressed together and re-oriented, can now largely return to a state that corresponds to the state prior to the sewing. The relaxed seam 6 acquires a virtually rectangular seam or tread pattern. Thus, it is obvious that, in the area of the sewing thread holes, only a very small indentation remains in the contour of the reinforcing-fiber preform 2 (or in the contour and structure of the preform subunit) in which large accumulations of resin with the associated drawbacks can no longer form.

After the final compacting, a suitable resin, for example, an epoxy resin, is injected into the injection mold and the resin is cured, for instance, under the effect of heat. After the curing, the component thus made of fiber composite material is removed from the injection mold and optionally conveyed to other processing steps.

By means of the method according to the invention, for example, lightweight and high-strength support rods for airplane doors or other components made of fiber composite material parts can be manufactured.

With the method according to the invention, depending on the type of component to be made of fiber composite material, the number of required reinforcing-fiber preforms 2 (or preform subunits) can naturally be varied. Relative to the total number of reinforcing-fiber layers 4 to be placed into the injection mold for the component to be made of fiber composite material or for part of a component thereof, in the method according to the invention, each of the reinforcing-fiber preforms 2 (or preform subunits) placed into the injection mold has on the average 10% to 25% , especially 10% to 20% , of the total number of reinforcing-fiber layers to be placed (or, in other words, the total number of reinforcing-fiber layers needed to build the component or a certain part of the component). Thus, if the component requires, for example, a total of 100 reinforcing-fiber layers 4 arranged on top of one another, then only 4 to 10, or 5 to 10 , reinforcing-fiber preforms 2 (or preform subunits) arranged on top of one another are needed to build the component.

It has been found, for example, that in order to produce a support rod for an airplane door by means of the method according to the invention, only 7 to 8 reinforcing-fiber preforms 2 (or preform subunits) are needed, in comparison to approximately 100 preforms in the case of a prior-art method. This translates into a considerable reduction of work and streamlining while also improving the mechanical properties. Moreover, the small number of reinforcing-fiber preforms 2 (or preform subunits) to be placed into the injection mold makes it possible to easily shift and align these with respect to each other whenever necessary.

For comparison purposes, FIG. 3 shows a schematic, greatly simplified cross section through a partial area of a component made of fiber composite material manufactured by means of a method according to the state of the art, having a reinforcing-fiber preform 2 in which the reinforcing-fiber layers 4 are likewise sewed together by means of a seam 6. It is evident here that the reinforcing fibers are markedly re-oriented and that there are relatively large, funnel-like indentations 8 with brittle or breakable resin accumulations 10 (indicated by hatching) in the area of the sewing thread holes.

The invention is not restricted to the above-mentioned embodiments, which merely serve to generally elucidate the core idea behind the invention. Rather, within the protective scope, the method according to the invention can assume other embodiments that differ from those concretely described above. In particular, the final compacting as such can be carried out only once the injection mold has already been closed. This can be done, for example, in that a membrane onto which pressure can be applied or else a slidable wall element is provided inside the injection mold which is only activated when the injection mold is in the closed state and which then exerts pressure onto the placed reinforcing-fiber preforms and subjects these to final compacting. Thus, “a final compacting by closing the injection mold” as employed in the invention should be understood in a broader sense.

The reference numerals in the claims, in the description and in the drawings merely serve to facilitate understanding of the invention and should not be construed as a restriction of the scope of protection.

List of reference numerals

2 reinforcing-fiber preform
4 reinforcing-fiber layer of 2
6 seam / thread
8 funnel-like indentations (in the state of the art)
10 resin accumulations (in the state of the art)
12 preform (in the state of the art)
14 injection mold (in the state of the art)
16 resin (in the state of the art)
18 component (in the state of the art)
D1 pre-compacting size
D2 final-compacting size
F compressive force for the final compacting
K1 sewing knot of 6
K2 sewing knot of 6
L partial length of the thread between KI and K2
S1-S7 process steps (in the state of the art)
W stitch width of 6

1-10. (canceled)

11. A method for producing a component made of fiber composite material, the method comprising:
sewing a plurality of reinforcing-fiber layers together using a thread to create a seam and to form at least one reinforcing-fiber preform, wherein the seam has a predetermined thread tension and the sewing pre-compacts the reinforcing-fiber preform to a pre-compacting size;
placing the at least one reinforcing-fiber preform into an injection mold;
performing a final compacting of the reinforcing-fiber preform to a final compacting size by closing the injection mold, wherein the final compacting includes relaxing the thread tension of the seam;
injecting a resin into the injection mold; and
curing the resin.

12. The method as recited in claim 10, wherein the final-compacting size is approximately 70% to 90% of the pre-compacting size.

13. The method as recited in claim 10, wherein the final-compacting size is approximately 75% to 80% of the pre-compacting size.

14. The method as recited in claim 10, wherein the thread that has a relaxation capacity.

15. The method as recited in claim 10, further comprising temporarily joining the plurality of reinforcing-fiber layers together before, during or after the sewing at one or more places using an adhesive.

16. The method as recited in claim 10, wherein the at least one pre-compacted reinforcing-fiber preforms includes a plurality of pre-compacted reinforcing-fiber preforms, and further comprising sewing the plurality of pre-compacted reinforcing-fiber preforms together so as to form pre-compacted preform subunits before the placing into the injection mold.

17. The method as recited in claim 10, wherein the at least one pre-compacted reinforcing-fiber preforms is placed loosely into the injection mold.

18. The method as recited in claim 16, wherein the pre-compacted preform subunits are placed loosely into the injection mold.

19. The method as recited in claim 10, wherein the component requires a total layer number of reinforcing-fiber layers and wherein the placing of the at least one reinforcing-fiber preform into the injection mold includes placing a fraction of the total layer number of reinforcing-fiber preforms.

20. The method as recited in claim 19, wherein the fraction is, on average 10% to 25%.

21. The method as recited in claim 20, wherein the fraction is less than 20%.

22. The method as recited in claim 16, wherein the component requires a total layer number of reinforcing-fiber layers and wherein the placing of the at least one reinforcing-fiber preform into the injection mold includes placing a number of pre-compacted preform subunits into the injection mold, wherein the number is a fraction of the total layer number.

23. The method as recited in claim 22, wherein the fraction is on average 10% to 25%.

24. The method as recited in claim 23, wherein the fraction is less than 20%.

25. The method as recited in claim 10, characterized in that the component is a support rod for an airplane door.

26. An intermediate product comprising:
at least one reinforcing-fiber preform having a plurality of reinforcing-fiber layers joined by a seam having a predetermined thread tension, the seam pre-compacting the at least one reinforcing-fiber preform to a pre-compacting size, wherein the at least one reinforcing-fiber preform is capable of undergoing a final compacting to a final-compacting size at which the predetermined thread tension of the seam is relaxed.

27. The intermediate product as recited in claim 26, wherein the at least one reinforcing-fiber preform includes at least two pre-compacted reinforcing-fiber preforms sewed to form a pre-compacted preform subunit.
